(19) United States
(12) Patent Application Publication
(10) Pub. No.: US 2019/0003356 A1
(43) Pub. Date: Jan. 3, 2019

(54) VALVE SLIDE AND SEPARATOR HAVING A VALVE SLIDE OF SAID TYPE

(71) Applicants: ThyssenKrupp Presta TecCenter AG, Eschen (LI); thyssenkrupp AG, Essen (DE)

(72) Inventors: Ulf Mueller, Chemnitz (DE); Robert Reichelt, Niederwiesa (DE)

(73) Assignees: ThyssenKrupp Presta TecCenter AG, Eschen (LI); thyssenkrupp AG, Essen (DE)

(21) Appl. No.: 16/018,418

(22) Filed: Jun. 26, 2018

(30) Foreign Application Priority Data
Jun. 30, 2017 (DE) 10 2017 114 645.8

(51) Int. Cl. F01M 13/02; B01D 45/08; F01M 13/04

(52) U.S. Cl. CPC F01M 13/023; F01M 2013/0044; F01M 13/04; B01D 45/08

(57) ABSTRACT

A valve slide may be used with a separator to separate a fluid such as oil out of a fluid-gas mixture. The valve slide may be insertable into the separator and can be impinged on by a flow of the fluid-gas mixture. To reduce the structural space of the separator, the valve slide may comprise a first slide and at least one second slide for closing and opening inlet openings of the separator. The first slide may be coupled to the second slide to permit simultaneous closing or opening of the inlet openings. The first slide may have a cross section through which the flow of the fluid-gas mixture can pass so as to conduct the fluid-gas mixture onwards to the at least one second slide.

### CROSS-REFERENCE TO RELATED APPLICATION

This application is an U.S. Non-provisional Patent Application that claims priority to German Patent Application No. DE 10 2017 114 645.8 filed Jun. 30, 2017, the entire contents of which are incorporated herein by reference.

### FIELD

The present disclosure generally relates to valve slides and separators, including valve slides for use in separators in internal combustion engines.

### BACKGROUND

The expression “valve slide” is to be understood in particular, but not exclusively, to mean a closure element that is insertable and displaceable in a valve and that can both completely shut off and open up, but also regulate, a throughflow of a fluid or fluid mixture through the valve.

Further, the expression “separator” is to be understood in particular, but not exclusively, to mean a valve with a valve slide designed for regulating a throughflow through the valve and with a separating element for separating a fluid, in particular out of a fluid-gas mixture. The separator may also be referred to as an “oil separator” if the fluid is oil.

In reciprocating-piston internal combustion engines, leakage gaps arise for structural reasons between cylinder wall and cylinder or the piston rings, through which leakage gaps parts of the combustion gas, so-called blow-by gases, pass from the cylinder into the crankcase. In order to avoid an “inflation” of the crankcase or a positive pressure in the crankcase, the crankcase must be ventilated, that is to say the blow-by gases are conducted out of the crankcase. The positive pressure can exert forces on moving parts of the internal combustion engine, and said parts can thus be impeded in performing their planned function. In a suitable separator, constituents such as oil, water and fuel are then separated out of the blow-by gas, and then, the “purified” gas is supplied to the intake tract again. Here, the purity of the purified gas is of increasing importance, along with, therefore, the demands on the effectiveness of the oil separator.

As is generally known, the flow rate of blow-by gas, or the magnitude of the blow-by volume flow, which arises at the piston rings during the fuel combustion in an internal combustion engine or piston compressor and which must subsequently pass the oil separator is dependent on the rotational speed and the torque of an internal combustion engine. At the separator, the discharged blow-by gas gives rise to a pressure loss, which is dependent on the cross section through which flow passes of the separator and on the discharged blow-by volume flow. In the case of separating systems in which the cross section through which flow passes is not of variable design, also referred to as “non-switchable separators,” the pressure increases with the square of the volume flow. Owing to the relatively high pressure, the quantity of separated-off constituents, or the magnitude of the separated-off volume flow, is increased.

However, the engine manufacturer normally at the same time predefines a maximum admissible pressure loss across the separator. It is thereby intended to ensure that the positive pressure in the crankcase does not excessively increase and does not exceed a particular limit value. However, this requirement applies independently of the load point, that is to say independently of the rotational speed and the torque of the internal combustion engine. Furthermore, the flow rate of the volume flow of blow-by gas at the internal combustion engine increases over the course of the engine life cycle. Therefore, the maximum occurring volume flow of the worn engine, for example 130 liters per minute, must be taken into consideration for the design of the separators.

Switchable separators, which can vary the cross section through which flow passes in a volume-flow-regulated manner, at load points with small volume flow (small cross section—high flow speed), already use more pressure energy for the separation than non-switchable separators, and are thus more efficient. In ranges of high volume flow, the switchable separators then open up a greater flow cross section in order, in the case of maximum volume flow, to be able to comply with the requirement of the maximum admissible pressure loss.

The adjustment of the flow cross section is normally performed by means of spring-loaded actuating elements/valves, wherein, owing to the pressure increase, further cross sections are opened. Normally, use is made here of slide valves or plate-type seat valves.

Plate-type seat valves according to the prior art have the disadvantage that, with the opening of the valve, a large cross section, which arises between the closed state of the valve and a first axial movement of the valve body, is opened up abruptly. This sudden opening-up of additional cross section leads in turn to a decrease of the pressure upstream of the valve. The decrease of the pressure then causes the valve to close again. This indifferent state of the valve (opening/closing) around the opening point can lead to wear to the valve seat and/or to acoustic conspicuities. Therefore, such valves are often used merely as safety or overpressure valves, but are more seldom used for the defined regulation of the pressure across the separator.

In the case of slide valves, the pressure at the upstream side acts on the surface of a slide, also referred to as valve slide, and, in the case of a pressure increase, moves the slide in a flow direction counter to a spring force. The movement of the slide then effects the opening of additional cross sections, or inlet openings, into the separator.

To achieve the most efficient possible oil separation for every blow-by volume flow, it is necessary for the opening-up of additional flow cross section to take place proportionally to the prevailing volume flow. The aim is an equally high flow speed in the separator while utilizing the available pressure potential.

An imaginary “ideal separator” utilizes the maximum admissible pressure loss over the entire volume flow range. In relation to the above-described non-switchable separator, a switchable separator with a single slide according to the prior art already utilizes more pressure potential in the case of relatively small volume flows. A further improvement relative to a switchable separator with single slide is provided through the use of a multiple slide, also referred to as “double slide.”

In the case of spring-loaded valves, a pressure difference is necessary for the adjustment/opening of the respective valve. Said difference should however be as small as possible, which, for the helical compression spring, leads to the demand for as small as possible a spring rate or spring constant. A small spring rate D means that, in the case of a spring force F, a greater deflection ΔL of the spring occurs—F=D·ΔL (Hooke's law). For small structural spaces of the valves, in particular with small outer diameter and short length, and the desired opening characteristic of the valve, the producibility of the helical compression springs in the case of the abovementioned valves reaches its limits (winding ratio max “20”—ratio of mean winding diameter to wire diameter of the spring). To realize springs with a small spring rate, it would be necessary for the springs to be longer, or for the winding ratio to be greater.

Slide valves according to the prior art are known from the following documents:

DE 102012008808 A1 describes a possibility of opening up the cross section in the event of a pressure increase by means of rotary slides, which is however disadvantageous here owing to the large structural space requirement.

DE 112007003054 B4 describes a separator with two flow paths, in the case of which the second flow path opens up variable/additional cross sections. As an actuating element, use is made here of a spring-loaded valve (flow controller). Here, an exemplary embodiment for a slide element is proposed which opens up further cross sections in the switched state.

DE102005043198 A1 generally describes a separator, the flow speed of which is variable by means of a parameter.

EP2406469 B1 describes a switchable separator which is integrated into a cavity, wherein, by means of a valve which is not described in any more detail, a second, parallel flow pass is opened up as soon as a certain pressure upstream of the separator is exceeded.

DE 10205981 A1 has likewise disclosed an arrangement with switchable cyclones. By means of a slide, the openings of the cyclones can be opened or closed. For this purpose, various cutouts are provided in the slide, which cutouts are each of a different size. The opening of the cyclone is thus open only in one position.

DE 102009035742 A1 describes a slide valve whose valve body is a ball.

It has hitherto been necessary in the case of known spring-loaded valves to accept a relatively large outer diameter or a relatively large spring length, or to accept a steep characteristic curve, with the disadvantage of the relatively poor utilization of the pressure energy available for the separation.

Thus a need exists to further improve a slide valve, in particular for separators, such that the disadvantages mentioned above or known from the prior art are overcome. In particular, a need exists in the case of slide valves to obtain as “soft” as possible a spring characteristic curve under constricted structural space requirements.

### BRIEF DESCRIPTION OF THE FIGURES

FIG. 1a is a perspective view of an example valve slide.

FIG. 1b is a front view of the example valve slide of FIG. 1a.

FIG. 1c is an enlarged detail view of an end section of the example valve slide of FIG. 1e.

FIG. 1d is a right side view of the example valve slide of FIG. 1e.

FIG. 1e is a plan view of the example valve slide of FIG. 1b.

FIG. 1f is a left side view of the example valve slide from FIG. 1e.

FIG. 2a is a half-sectional side view of an example nonwoven carrier for an example valve slide like that shown in FIG. 1a.

FIG. 2b is a cross-sectional view of the example nonwoven carrier of FIG. 2a.

FIG. 2c is a left side view of the example nonwoven carrier of FIG. 2a.

FIG. 2d is an enlarged detail view of an example nozzle of the example nonwoven carrier of FIG. 2a.

FIG. 2e is an enlarged detail view of an example detent lug of the example nonwoven carrier of FIG. 2a.

FIG. 3 is an exploded view of another example valve slide with a spring and with a nonwoven carrier from FIG. 2a.

FIG. 4a is a cross-sectional view of the example valve slide of FIG. 3 inserted into a nonwoven carrier, in a shut-off state.

FIG. 4b is a cross-sectional view of the example valve slide of FIG. 3 inserted into a nonwoven carrier, in an open state.

FIG. 4c is an enlarged detail view of an example slide of the example valve slide of FIG. 4a.

FIG. 5a is a longitudinal sectional view, from a side elevation, of an example separator inserted in a housing, in a closed state.

FIG. 5b is a cross-sectional view of the example separator of FIG. 5a.

### DETAILED DESCRIPTION

Although certain example methods and apparatuses have been described herein, the scope of coverage of this patent is not limited thereto. On the contrary, this patent covers all methods, apparatuses, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

A valve slide for a separator may be used to separate a fluid such as oil, for instance, out of a fluid-gas mixture. In some examples, the valve slide is insertable into the separator and can be impinged on by the flow of the fluid-gas mixture. The valve slide may comprise a first slide and at least one second slide, positioned downstream in a flow direction, for closing and opening inlet openings of the separator. The first slide may be coupled to the at least one second slide to permit simultaneous closing or opening of the inlet openings. The first slide may comprise a cross section through which flow can pass to conduct the fluid-gas mixture onwards to the at least one second slide.

This has the advantage that the valve slide is formed as a multiple slide and can open up a greater flow cross section, or multiple flow inlet openings, into the separator. This means that the slides, owing to the coupling to one another, can open up the inlet openings, assigned thereto, of the slide valve simultaneously. Thus, with the same travel of the valve slide (or spring travel), a greater cross section can be opened up. This effect corresponds to a “relatively soft” spring (greater spring travel with the same force), in the case of which a greater cross section would be opened up by means of a normally relatively large valve slide travel.

Furthermore, the cross section through which flow can pass of the first slide has the advantage that the fluid-gas mixture always strikes the at least one second slide independently of the position of the valve slide in the valve. In this way, the throughflow of the fluid-gas mixture can simultaneously be regulated or shut off by the first slide and by the at least one second slide.

It has likewise proven to be advantageous if the valve slide comprises at least one detent lug for axially securing the valve slide in the separator. It is thereby sought to ensure that a valve slide inserted into a separator does not overshoot a predetermined travel distance in the separator, or is not automatically released from the separator for example by a spring force.

The valve slide is advantageously formed with a relative rotation prevention means, in particular in the form of a double flat, in order, in a state inserted in the separator, to prevent a rotation about an axis of the valve slide. This yields the advantage that, during the displacement of the valve slide within the separator, always the same surfaces or elements of the valve slide come into contact with the separator.

In a further advantageous embodiment, the valve slide comprises a centring collar as a stop for a spring that can be pulled onto the valve slide. In this way, firstly, a limitation of the travel of the spring on the valve slide is realized. Furthermore, the collar assists in preventing a lateral deflection of the spring during a compression. Here, the centring collar advantageously comprises a diameter which substantially corresponds to the inner diameter of the spring.

The at least one second slide preferably comprises radially formed ribs, or ribs of a radiating form. This has the advantage not only that a stable structure is formed but also that a uniform flow stream along the ribs to the at least one second slide is made possible. The uniform flow stream assists in realizing softer switching or regulation of the valve slide.

The first slide is advantageously fixedly connected to or formed with the radially formed ribs of the second slide positioned downstream in the flow direction. In this way, the first slide is arranged or fastened in a stable manner on the flow tip of the valve slide.

It has likewise proven to be advantageous if the at least one second slide comprises a diverting cone which can be impinged on by the flow of the fluid-gas mixture. This has the advantage that the flow stream is conducted uniformly, and with little or no flow turbulence, into the separator.

It is additionally emphasized that the valve slide according to the present disclosure may also be suitable for slide valves other than a valve that can be inserted in a separator. Furthermore, the valve slide is suitable not only for fluid-gas mixtures but also for liquids and/or gases.

Furthermore, it is possible for more than two slides to be formed on the valve slide, in order to increase the regulable cross section through the separator. The slides are arranged spaced apart from one another and one behind the other in the flow direction along the axis of the valve slide. Here, it must be ensured that each slide can be connected to the flow stream through the cross section through which flow can pass of the first slide, or each slide comprises a flow connection to the first slide, independently of the switching state of the valve slide. In order that, in the case of multiple slides, the slides comprise a flow connection and the valve slide is deflected uniformly counter to a spring by the fluid-gas pressure or flow, the slides and the flow connection thereof to the first slide are advantageously formed such that the major part of the pressure/flow acts against that one of the slides which is arranged last in the flow direction.

The cross section through which flow can pass advantageously comprises at least one flow duct which extends along the axis and which connects an upstream side to a downstream side of the first slide. This has the advantage that the fluid-gas mixture can be conducted in controlled fashion through the first slide.

The present disclosure likewise relates to a separator for separating oil out of an oil-gas mixture, in particular out of a blow-by gas, having a nonwoven carrier, having a nonwoven and having a valve slide according to the present disclosure, wherein the nonwoven is arranged at least partially around the nonwoven carrier. Furthermore, the nonwoven carrier comprises a flow inlet funnel (also referred to as inlet funnel) for the oil-gas mixture and comprises a valve slide receptacle, wherein the flow inlet funnel is formed with nozzles arranged radially around an axis of the nonwoven carrier, and the valve slide receptacle is formed with inlet openings which are arranged radially around the axis of the nonwoven carrier and which are axially spaced apart, wherein the inlet openings are provided for being closed or opened simultaneously by means of a displacement of the valve slide along the axis.

This yields the advantage that, owing to the nozzles, the separator always comprises a minimum passage cross section for the blow-by gas. As soon as the volume flow of the oil-gas mixture increases, a throughflow cross section larger than that in the prior art is opened up by means of the valve slide according to the present disclosure; in particular, the spring can be adapted for a small structural space, or the spring can be reduced in size. Furthermore, this yields simpler setting of the desired characteristic curve of the separator. The distribution of the cross sections for opening up on the respective slide element likewise yields optimum utilization of the nonwoven surface (in the case of nonwoven being used as a separating element). More efficient utilization of the available pressure potential for the oil separation in the part-load range (low rotational speed, low load) of the engine characteristic map is also possible, and of significance because part-load ranges account for a major part of the time in the overall life cycle of the engine.

It is preferable if the outlets of the nozzles are directed towards an end surface of the nonwoven, and the outlets of the inlet openings are directed towards an inner shell surface of the nonwoven. This has the advantage of uniform and thus optimum utilization of the separating element.

For the switching capability of the separator, it is advantageous for a spring to be pulled onto the valve slide and to be arranged radially between valve slide and valve slide receptacle and to be preloaded in the direction of the helical spring axis, wherein a force of the spring acts on the valve slide in the direction of the flow inlet funnel.

It has likewise proven to be advantageous if the flow inlet funnel narrows conically towards the valve slide receptacle, and the valve slide receptacle is formed as a hollow cylindrical sleeve with a base opening, wherein the valve slide is inserted into the base opening and is prevented from being completely pulled out by detent engagement means, in particular by at least one detent lug, of the valve slide. The conical form gives rise to a uniform flow stream with little turbulence, and thus a pressure loss. Owing to the engagement of the detent engagement means with the base opening, no further fastening means are required for axially securing the valve slide.

The valve slide receptacle and the valve slide are advantageously in engagement with one another, and/or formed, such that a relative rotation of the valve slide about the axis is prevented. It can be ensured in this way that the slides open or close the corresponding inlet openings in the valve slide receptacle of the nonwoven carrier; even if the slide does not comprise a continuous ring-shaped outer surface.

It has furthermore proven to be advantageous if the valve slide receptacle comprises a base opening in which the valve slide is arranged in axially displaceable fashion and so as to be secured against relative rotation by means of a positively locking connection. This guide characteristic supports the consistent function of the valve slide during the opening and closing of the inlet openings of the nonwoven carrier.

The positively locking connection is advantageously formed by a double flat formed on the valve slide and by a corresponding profiling of the base opening, and is simple and inexpensive to produce, and functions reliably.

For the valve slide and for the separator, it is not necessary to use a nonwoven material as separating element, or a flow-optimized diverting cone for reducing the pressure loss. It is likewise possible for both features to be used in rotating and in static systems. Furthermore, the cross sections to be opened up in each case on the respective slide may be varied in order to permit optimum utilization of the nonwoven surface and a uniform impingement of flow. The spacings of the opening lines on the multiple slide and of the opening line of the nozzles in the nonwoven carrier may also differ in size. This would have the effect that the closed radial cross sections at the slide edges would be opened up at different spring travels.

The present disclosure will be discussed in more detail below with reference to the schematic drawings of a preferred exemplary embodiment with further details.

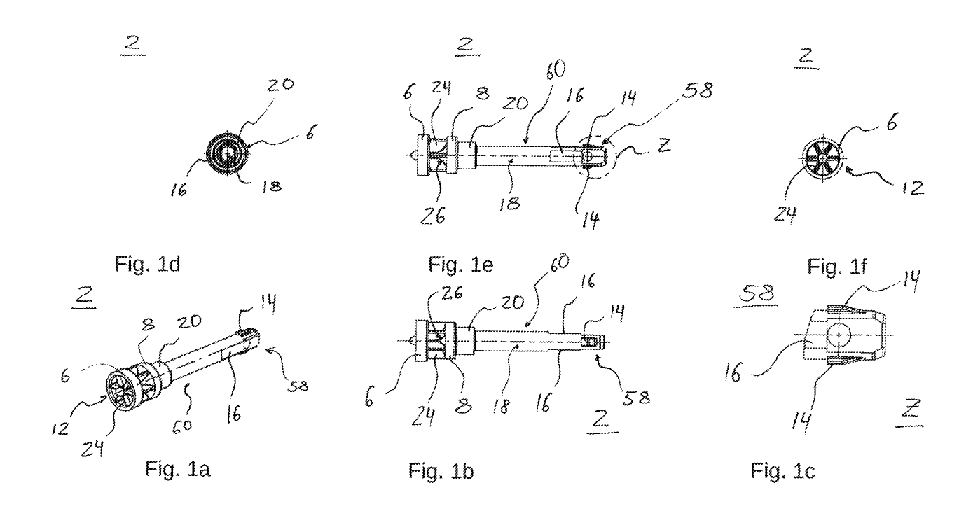

FIGS. 1a to 1f show different views of a valve slide 2 according to a preferred exemplary embodiment. The valve slide 2 is of bolt-like form along an axis 18. Said valve slide comprises a tip of flow-optimized form. The tip is optional. Downstream of the tip in a flow direction, the valve slide 2 comprises a ring-shaped first slide 6.

The first slide 6 comprises a cross section through which flow can pass 12. During operation, a fluid-gas mixture can thus flow through the first slide 6 along the axis 18. For this purpose, the cross section through which flow can pass 12 comprises at least one, in particular multiple, for example six, flow ducts which extend along the axis 18 and which connect an upstream side, in particular end side, to a downstream side, in particular end side, of the first slide 6. A different number of flow ducts is possible.

In other words, the ring-shaped first slide 6 comprises a circular cross section which can at least partially be passed through by flow.

Other geometries of the first slide 6 are possible.

Downstream of the first slide 6 in a flow direction, the valve slide 2 comprises a second slide 8 which is spaced apart axially from said first slide in the flow direction. From the second slide 8, six ribs 24 which are formed in a radiating configuration from the axis 18 extend into the first slide 6. The ribs 24 form the mutually separate flow ducts which connect the first slide 6 and the second slide 8.

The second slide 8 comprises, on its side facing toward the first slide 6, a diverting cone 26 which, from its outer side, runs in concavely curved fashion in the direction of the first slide 6 toward the axis 18. Directly below the second slide 8 in an axial direction, there is arranged a cylindrical centring collar 20 which comprises a smaller diameter than the second slide 8 and which serves for providing a stop and a receiving/bearing surface for a spring. A cylindrical spring carrier section 60 and an end section 58 are formed so as to follow the centring collar 20. On two opposite sides of the spring carrier section 60, there is formed a double flat 16 as a relative rotation prevention means for a receptacle (not illustrated). The double flat 16 extends from one point of the spring carrier section 60 to the end section 58. On the end section 58, on the outer side thereof, there are formed two oppositely situated detent lugs 14, which are arranged so as to be rotated through 90 degrees in relation to the double flat 16. When the valve slide 2 is inserted into the nonwoven carrier 28, an elastic deformation, in particular an elastic expansion, of the bore or base opening 50 of the nonwoven carrier 28 occurs, in order for the end section 58 with its detent lugs 14 to be led through. After the detent lugs 14 have passed through the bore 50, the bore 50 resumes its original form—it relaxes. This gives rise to a positive locking action for the axial securing (detent engagement) of the slide 2 with the nonwoven carrier 28. In other advantageous embodiments, the detent lugs may additionally or alternatively be elastically deformable.

A double flat is to be understood to mean a component of a positively locking connection which comprises at least two planar abutment surfaces which interact with a corresponding counterpart of the receptacle as a relative rotation prevention means. A different number of abutment surfaces, for example a single abutment surface (single flat) or generally multiple abutment surfaces (multiple flat) are possible.

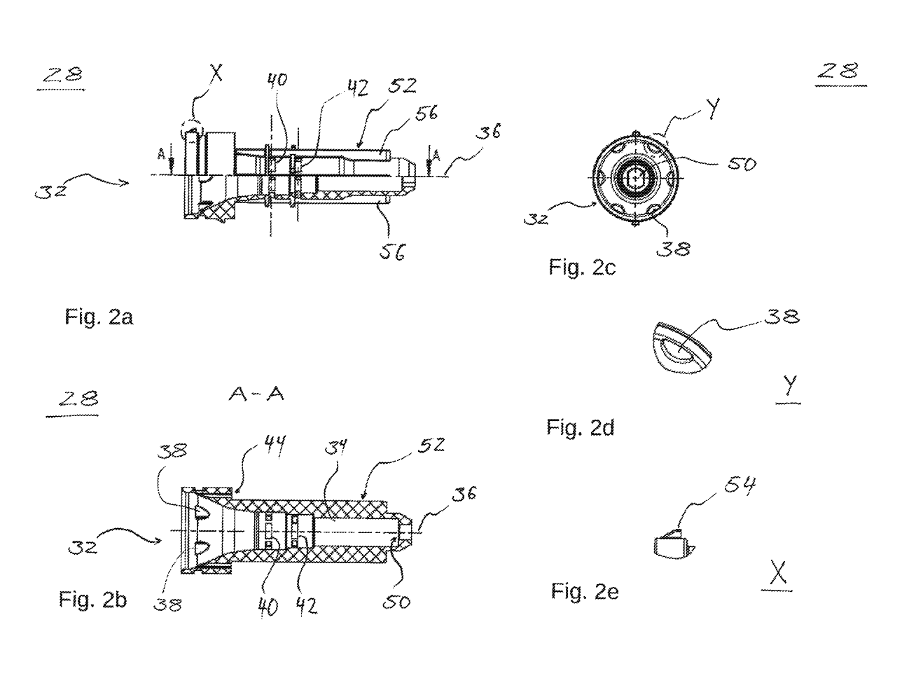

FIGS. 2a to 2e show different views of a nonwoven carrier 28 which serves as a receptacle or sleeve for the valve slide 2 (not illustrated) and as a carrier for a nonwoven (not illustrated). The nonwoven carrier 28 is of bolt-like, in particular hollow cylindrical, form along an axis 36 and is divided into a flow inlet funnel 32 and a valve slide receptacle 34. The funnel 32 comprises a greater diameter than the receptacle 34 in order that a separating element, in particular in the form of a nonwoven, can be arranged flush with the outer surface of the funnel 32 on the receptacle 32. The outer side of the funnel 32 comprises a cylindrical shell surface with multiple non-deformable detent lugs 54. The inner side of the funnel 32 narrows conically toward the receptacle 34 and comprises nozzles 38 which are formed so as to be concentric around the axis 36 and uniformly spaced apart from one another; in this example, six nozzles 38 are provided. Said nozzles 38 conduct a blow-by gas via the respective duct thereof to corresponding outlets 44 in the direction of the receptacle 34, in particular parallel to the nonwoven carrier surface 52 on the outer side of the receptacle 34. Here, the inlet, formed at the inner side of the funnel 32, of the nozzles 38 comprises a larger cross section than the outlet 44 thereof, whereby the blow-by gas is accelerated. On the outer side of the valve slide receptacle 34, there are formed multiple carrier webs 56 or ribs from the lower edge of the funnel 32 to a short distance in front of a base opening 50 of the receptacle 34, wherein the webs 56 are formed parallel to the axis 36 and in radiating fashion, and the cylindrical circumference of the webs 56 forms the nonwoven carrier surface 52. The base opening 50 is a substantially circular bore with two double flats, the cross section of which is identical to that of the valve slide described above and thus permits an axial displacement, secured against relative rotation, of the valve slide along the axis 36. Similarly to the arrangement of the nozzles 38, first inlet openings 40 and second inlet openings 42 to the outer side of the receptacle 34 are provided, which inlet openings are arranged on the inner shell surface of the receptacle 34 and concentrically around the axis 36. The form or the cross section of each inlet opening 40, 42 is rectangular in a plan view.

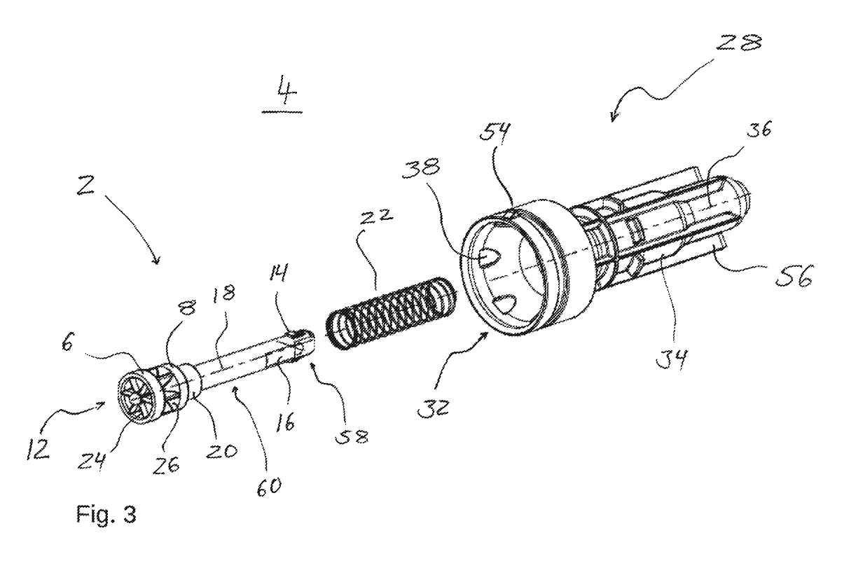

FIG. 3 shows an exploded view of a separator 4 with a valve slide 2 from FIGS. 1a to 1f, with a nonwoven carrier 28 from FIGS. 2a to 2e, and with a spring 22, but without separating element or nonwoven. It can be seen here that the axes 18 and 36 of the valve slide 2 and of the nonwoven carrier 28 are identical. The spring 22 functions as a switching means for the valve slide 2 and is compressed in a manner dependent on the blow-by gas volume flow or pressure. As soon as the volume flow or pressure falls below a limit value, the valve slide 2 is displaced by the spring 22 into an initial or closed position.

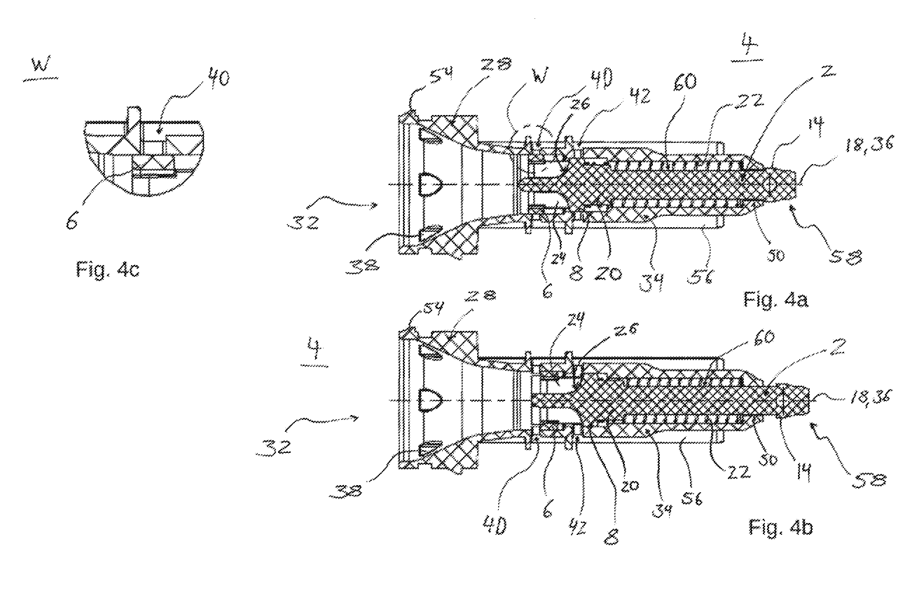

FIGS. 4a to 4c show various cross-sectional views of an assembled separator 4 from FIG. 3. Here, in FIGS. 4a and 4c, the inlet openings 40 and 42 are completely covered by the first and second slides 6 and 8, and are thus closed. This position is referred to as initial or closed position of the separator 4, in particular of the valve slide 2, and is realized if the volume flow or pressure of the blow-by gas falls below a particular value. The position of the valve slide 2 is, in the closed position, determined substantially by the position of the detent lugs 14, which, beyond a certain point, engage with the lower edge of the base opening 50 and block a further displacement of the valve slide 2 by the spring 22. In the presence of a small volume flow, it is thus the case that all of the blow-by gas flows through the axial nozzles 38 of the nonwoven carrier 28 and impinges directly on the separating medium (not illustrated). The cross section of the axial nozzles is kept relatively small (for example approximately 15 mm²), such that, in the case of a volume flow of approximately 30 liters/min, a total pressure difference of approximately 8 mbar takes effect across the separator 4. In FIG. 4b, the inlet openings 40 and 42 are fully open, and are not partially covered by the first and second slides 6 and 8. This position is referred to as open position of the separator 4, in particular of the valve slide 2, and is realized if the volume flow or pressure of the blow-by gas falls below a particular value. This means that, at load points with a relatively large blow-by volume flow, the pressure upstream of the slide 2 increases. As a result, the multiple valve slide 2 moves to the “right” and compresses the helical spring 22 by a spring travel. Owing to the coupling of the two slides 6 and 8 (and the equal spacing of the opening lines on the multiple slide 2 end of the opening lines of the inlet openings 40, 42 in the nonwoven carrier 28), it is now simultaneously the case that the radial cross sections are opened up, and the blow-by gas flow is divided into not only the flow through the nozzles 38 but also into two further partial flows through the inlet openings 40 and 42. The gas flow can thus be distributed over a larger area of the separating element (not illustrated), and thus the oil separation can be improved.

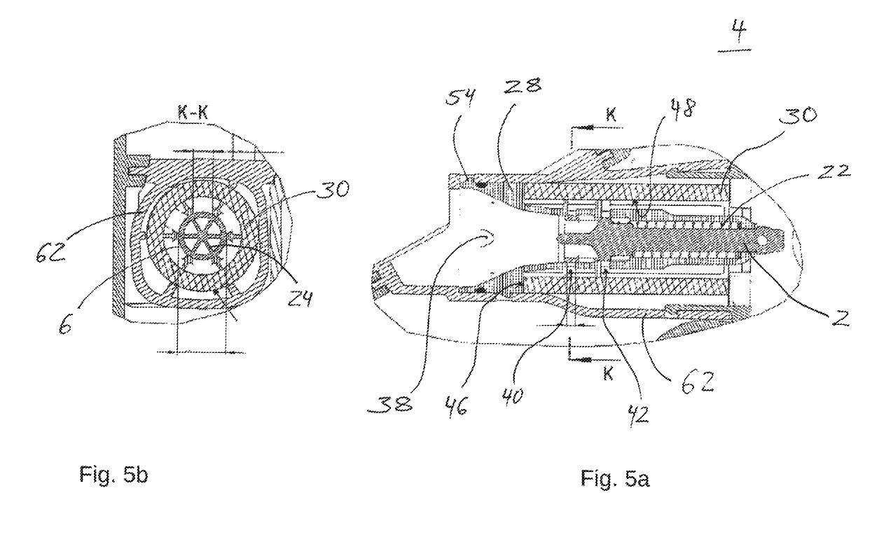

FIGS. 5a and 5b show different views of a separator 4 from FIG. 4a with a nonwoven 30, which is inserted into a housing 62. The housing 62 serves in this case for capturing or collecting the separated-off oil and conducting said oil onwards. Here, the separator 4, in particular the nonwoven carrier 28, is fastened in the housing 62 by means of the detent lugs 54. The inlet opening 40 shown in FIG. 5a comprises, in this example, a width of 1.5 mm, but is in general not restricted to this value. The cross section K-K from FIG. 5a, shown in FIG. 5b, runs at the level of the first slide 6, which in this example comprises an outer diameter of 8.8 mm (see the lower distance dimension in FIG. 5b), but is in general not restricted to this value. Here, the outer diameter of the first slide 6 corresponds to the inner diameter of the inlet opening 40. The width at the radial and between the ribs 24 preferably amounts to 3.7 mm (see the upper distance dimension in FIG. 5b). In the presence of a small blow-by volume flow onto/into the separator 4, the valve slide 2 is not displaced owing to the relatively high force of the spring 22 counter to the flow. As a result, the inlet openings 40, 42 remain closed by the slides 6 and 8, and all of the blow-by gas is conducted through the nozzles 38 onto the front side or end surface 46 of the nonwoven 30, and thus into the nonwoven 30. As soon as the volume flow increases, the pressure on the valve slide 2 and thus on the spring 22 also increases. Here, the valve slide 2 is displaced and at least partially opens the inlet openings 40, 42. As a result, the blow-by gas can be conducted not only through the nozzles 38 but also through the inlet openings 40, 42 onto the inner shell surface 48 of the nonwoven 30. This means that the flow paths of the blow-by gas run firstly through the nozzles 38 and furthermore via the inlet openings 40, 42 onto the nonwoven 30. As soon as the spring force corresponds to the pressure of the volume flow, the valve slide 2 is displaced no further, and the spring 22 is compressed no further.

What is claimed is:

1. A valve slide for a separator for separating a fluid out of a fluid-gas mixture, wherein the valve slide is insertable into the separator and is configured to be impinged by a flow of the fluid-gas mixture, the valve slide comprising:
a first slide having a cross section; and
a second slide positioned downstream of the first slide in a flow direction of the fluid-gas mixture, the first and second slides configured to close and open inlet openings of the separator,
wherein the first slide is coupled to the second slide to permit simultaneous closing or opening of the inlet openings,
wherein the cross section of the first slide is configured so as to permit the flow of the fluid-gas mixture to pass through the cross section and to conduct the fluid-gas mixture onwards to the second slide.

2. The valve slide of claim 1 comprising a detent lug for axially securing the valve slide in the separator.

3. The valve slide of claim 1 comprising a rotation prevention means to prevent relative rotation about an axis of the valve slide between the valve slide and the separator when the valve slide is inserted into the separator.

4. The valve slide of claim 1 comprising a double flat for preventing relative rotation about an axis of the valve slide between the valve slide and the separator when the valve slide is inserted into the separator.

5. The valve slide of claim 1 comprising a centring collar as a stop for a spring that can be pulled onto the valve slide.

6. The valve slide of claim 1 wherein the second slide comprises radially-formed ribs.

7. The valve slide of claim 6 wherein the first slide is fixedly connected to the radialy-formed ribs of the second slide positioned downstream in the flow direction.

8. The valve slide of claim 1 wherein the second slide comprises a diverting cone that is configured to be impinged on by the flow of the fluid-gas mixture.

9. The valve slide of claim 1 wherein the cross section of the first slide comprises a flow duct that extends along an axis and connects an upstream side of the first slide to a downstream side of the first slide.

10. A separator for separating oil out of an oil-gas mixture, the separator comprising:
a nonwoven carrier comprising
a flow inlet funnel for the oil-gas mixture, wherein the flow inlet funnel includes nozzles arranged radially around an axis of the nonwoven carrier, and
a valve slide receptacle with inlet openings that are arranged radially around the axis of the nonwoven carrier and that are spaced axially apart;
a nonwoven disposed at least partially around the nonwoven carrier; and
a valve slide that includes a first slide having a cross section and a second slide positioned downstream of the first slide in a flow direction of the oil-gas mixture, the first and second slides configured to close and open the inlet openings, wherein the first slide is coupled to the second slide to permit simultaneous closing or opening of the inlet openings, wherein the cross section of the first slide is configured so as to permit a flow of the oil-gas mixture to pass through the cross section and to conduct the oil-gas mixture onwards to the second slide,
wherein the inlet openings of the valve slide receptacle of the nonwoven carrier are closed or opened simultaneously by displacement of the valve slide along the axis of the nonwoven carrier.

11. The separator of claim 10 wherein the nozzles are directed towards an end surface of the nonwoven, wherein outlets of the inlet openings are directed towards an inner shell surface of the nonwoven.

12. The separator of claim 10 comprising a spring pulled onto the valve slide and positioned radially between the valve slide and the valve slide receptacle, the spring being preloaded in a direction of a helical spring axis, wherein a force of the spring acts on the valve slide in a direction of the flow inlet funnel.

13. The separator of claim 10 wherein the flow inlet funnel narrows conically towards the valve slide receptacle, wherein the valve slide receptacle is configured as a hollow cylindrical sleeve with a base opening, wherein the valve slide is inserted into the base opening and is prevented from being completely pulled out by a detent engagement means of the valve slide.

14. The separator of claim 13 wherein the detent engagement means is a detent lug.

15. The separator of claim 10 wherein the valve slide receptacle and the valve slide are at least one of engaged with one another or formed so as to prevent a relative rotation of the valve slide about the axis of the nonwoven carrier.

16. The separator of claim 15 wherein the valve slide receptacle comprises a base opening in which the valve slide is disposed in an axially displaceable fashion and so as to be secured against relative rotation by way of a positively locking connection.

17. The separator of claim 16 wherein the positively locking connection is formed by a double flat formed on the valve slide and by a corresponding profiling of the base opening.
